(19) United States
(12) Patent Application Publication
(10) Pub. No.: US 2023/0005088 A1
(43) Pub. Date: Jan. 5, 2023

(54) IDENTIFYING TROUBLED CONTRACTS

(71) Applicant: International Business Machines Corporation, Armonk, NY (US)

(72) Inventors: CHRISTOPHER PHIPPS, Chico, CA (US); CATHERINE DESESA, Wilmette, IL (US); Kaitlyn Leedy, Frostburg, MD (US); Matthew Bellio, Chicago, IL (US); Charles E. Beller, Baltimore, MD (US)

(21) Appl. No.: 17/355,356

(22) Filed: Jun. 23, 2021

(51) Int. Cl. G06Q 50/18; G06F 40/247; G06K 9/00; G06N 20/00

(52) U.S. Cl. CPC G06Q 50/18; G06F 40/247; G06K 9/00442; G06N 20/00

(57) ABSTRACT

In an approach for identifying troubled contracts using a health score, a processor receives a contract. A processor identifies a list of requirements of the contract using a first Natural Language Processing technique. A processor trains a model to recognize the list of requirements of the contract. A processor receives at least one deliverable document associated with the contract. A processor applies a plurality of health metrics to the at least one deliverable document associated with the contract to identify evidence of completion of each requirement of the list of requirements of the contract. A processor outputs the health score for each requirement of the list of requirements of the contract.

### STATEMENT REGARDING FEDERALLY SPONSORED RESEARCH OR DEVELOPMENT

This invention was made with U.S. Government support under contract number W15QKN-17-9-5555 awarded by the Department of Defense. The U.S. Government has certain rights to this invention.

### BACKGROUND OF THE INVENTION

The present invention relates generally to the field of data processing, and more particularly to identifying troubled contracts using a health score.

A contract is a promise or set of promises for the breach of which the law gives a remedy or the performance of which the law, in some way, recognizes as a duty. A contract typically involves the exchange of goods, service, money, or the promise of any of those.

A contract is typically managed from its creation through its execution and to its termination. This process is referred to as contract management. A contracting party's performance of a contract is also analyzed to maximize the contracting party's operational and financial performance and to mitigate any financial or reputational risk through non-compliance with contract terms.

The contracting parties may choose to manage their contract manually or may use a contract management software. Contract management software provides a contracting party with a way to create contracts, using tools with contract authoring and collaboration capabilities. Contract management software also provides a contracting party with a way to organize, store, and manage their contracts. Contract management software digitizes and stores contracts in a central digital contract repository, providing the contracting party with a way to search and review its contract and eliminating the need to manually locate and sift through stacks of paper.

### SUMMARY

Aspects of an embodiment of the present invention disclose a method, computer program product, and computer system for identifying troubled contracts using a health score.

In some aspects of an embodiment of the present invention, a processor receives a contract. A processor identifies a list of requirements of the contract using a first Natural Language Processing (NLP) technique. A processor trains a model to recognize the list of requirements of the contract. A processor receives at least one deliverable document associated with the contract. A processor applies a plurality of health metrics to the at least one deliverable document associated with the contract to identify evidence of completion of each requirement of the list of requirements of the contract. A processor outputs the health score for each requirement of the list of requirements of the contract.

In some aspects of an embodiment of the present invention, a processor extracts a first set of data from the at least one deliverable document associated with the contract using the first NLP technique. A processor creates a first table to manage the first set of data extracted from the at least one deliverable document associated with the contract.

In some aspects of an embodiment of the present invention, a processor calculates a size of the at least one deliverable document associated with the contract. A processor identifies one or more sections of the at least one deliverable document associated with the contract related to the list of requirements of the contract using a second NLP technique. A processor extracts a second set of data from the one or more sections of the at least one deliverable document associated with the contract identified as related to the list of requirements of the contract. A processor creates a second table to manage the second set of data. A processor applies a month-to-month comparison matrix to the second set of data to track one or more changes in the second set of data. A processor creates a third table by linking the data in the first table and the data in the second table. A processor identifies evidence of a common linkage between the contract and the at least one deliverable document associated with the contract in a column of the third table containing a set of text of the at least one deliverable document associated with the contract. A processor generates one or more synonyms of the list of requirements using the second NLP technique. A processor identifies the one or more synonyms of the list of requirements found in a first column of the third table. A processor merges the data in the second table with the data in the third table to create a fourth table with the evidence of completion of each requirement of the list of requirements. A processor calculates the health score for each requirement of the list of requirements of the contract by applying a success-model with a pre-set failure threshold to the evidence of completion of each requirement of the list of requirements of the contract.

In some aspects of an embodiment of the present invention, the size of the at least one deliverable document associated with the contract is calculated by counting a plurality of characters in the at least one deliverable document associated with the contract, by counting one or more sentences written in the at least one deliverable document associated with the contract, by counting one or more paragraphs written in the at least one deliverable document associated with the contract, or by counting one or more bullet points used in the at least one deliverable document associated with the contract.

In some aspects of an embodiment of the present invention, the one or more changes tracked in the second set of data includes a difference in the size of the at least one deliverable document associated with the contract currently being analyzed from the at least one deliverable document associated with the contract previously analyzed, a difference in a headcount of the at least one deliverable document associated with the contract currently being analyzed from the at least one deliverable document associated with the contract previously analyzed, and a difference in a sentiment of the at least one deliverable document associated with the contract currently being analyzed from the at least one deliverable document associated with the contract previously analyzed.

In some aspects of an embodiment of the present invention, a processor scores the evidence of completion of each requirement of the list of requirements of the contract. A processor classifies the evidence of completion of each requirement of the list of requirements of the contract based on the health score calculated.

In some aspects of an embodiment of the present invention, the evidence of completion of each requirement of the list of requirements of the contract is classified as “successful” when the evidence of completion shows progress on a requirement on the list of requirements and scores above the pre-set failure threshold of the success-model or as “not successful” when the evidence of completion shows failure to make progress on a requirement on the list of requirements and scores below the pre-set failure threshold of the success-model.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps for a setup component of a troubled contracts program, on a server within the distributed data processing environment of FIG. 1, in accordance with an embodiment of the present invention;

FIG. 3 is a flowchart illustrating the operational steps of the troubled contracts program, on the server within the distributed data processing environment of FIG. 1, in accordance with an embodiment of the present invention;

FIG. 4 is a flowchart illustrating, in greater detail, the operational steps of an analysis step of the troubled contracts program, on the server within a distributed data processing environment of FIG. 1, in accordance with an embodiment of the present invention; and

FIG. 5 is a block diagram illustrating the components of a computing device in the distributed data processing environment of FIG. 1, in accordance with an embodiment of the present invention.

### DETAILED DESCRIPTION

Embodiments of the present invention recognize that contracts dictate many aspects of key business strategies and relationships. When a contracting party knows the terms of its contract, the contracting party is in a better position to enforce its contractual rights and comply with its obligations. If a contracting party fails to exercise its rights, the contracting party may leave money on the table. Further, losing track of commitments and later getting blindsided by those commitments can be immensely costly to a contracting party. Therefore, effective contract management is essential to a business.

Embodiments of the present invention recognize that, despite the risks, many contracting parties continue to rely on manual processes and inefficient tools to create, organize, store, and manage its contracts. Embodiments of the present invention recognize the need for a more effective approach to managing the performance of a contract. Embodiments of the present invention recognize the need for an approach to analyze and compare multiple documents associated with a contract over a period of time. With such an approach, embodiments of the present invention recognize that the operational and financial performance of a contracting party can be maximized, and any financial or reputational risk through non-compliance with contract terms can be minimized.

Embodiments of the present invention provide an improvement to traditional contract management software with a system and method for identifying troubled contracts by analyzing the data within an original contract (hereinafter referred to as an “originating contract”) and at least one follow-up status tracker document (hereinafter referred to as a “deliverable document associated with the contract”) and by outputting a health score based on the analysis of the data. A deliverable document associated with the contract is a status tracking document, i.e., a document that provides an update on the status of a deliverable required in the originating contract.

Implementation of embodiments of the present invention may take a variety of forms, and exemplary implementation details are discussed subsequently with reference to the Figures.

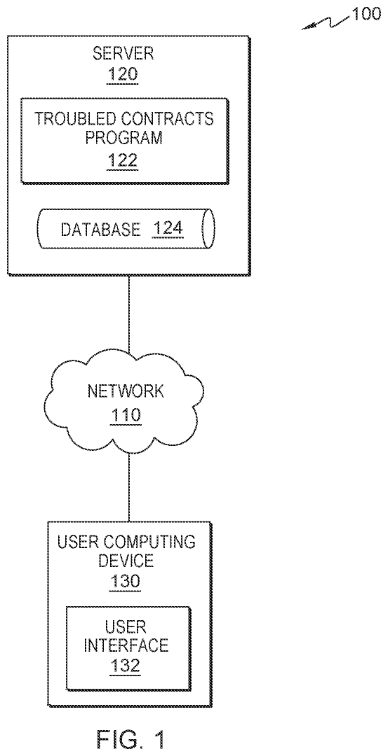

FIG. 1 is a functional block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations regarding the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between server 120, user computing device 130, and other computing devices (not shown) within distributed data processing environment 100.

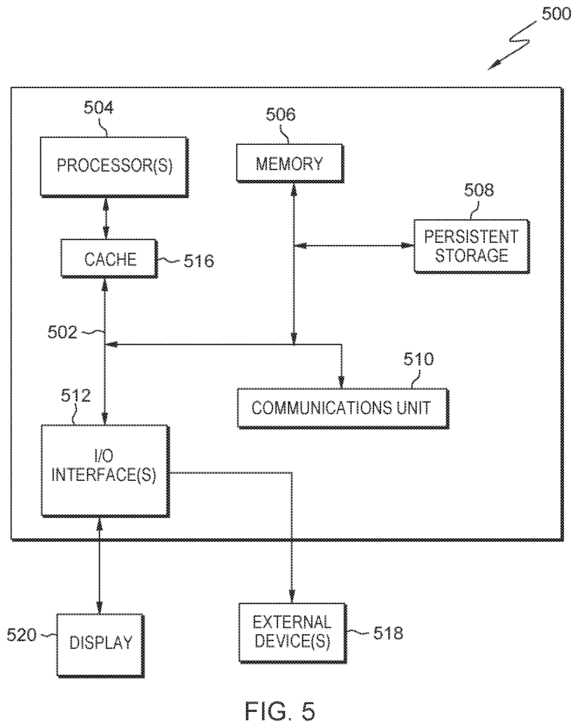

Server 120 operates to run troubled contracts program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 5.

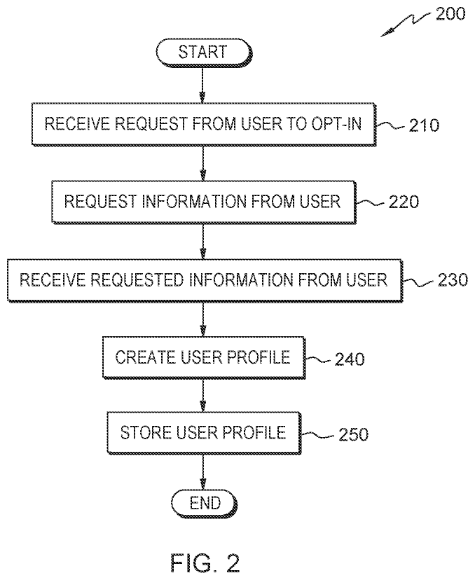

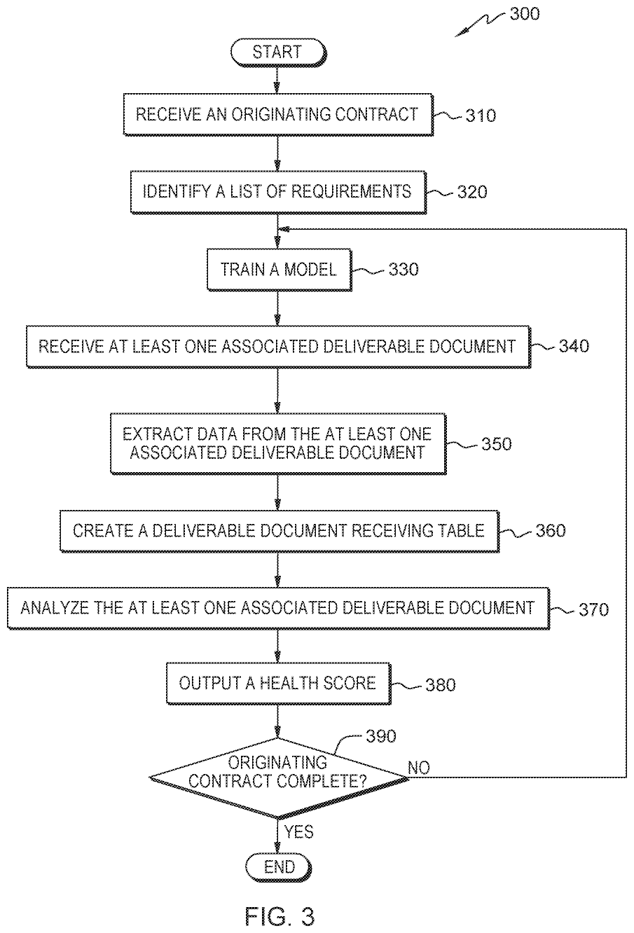

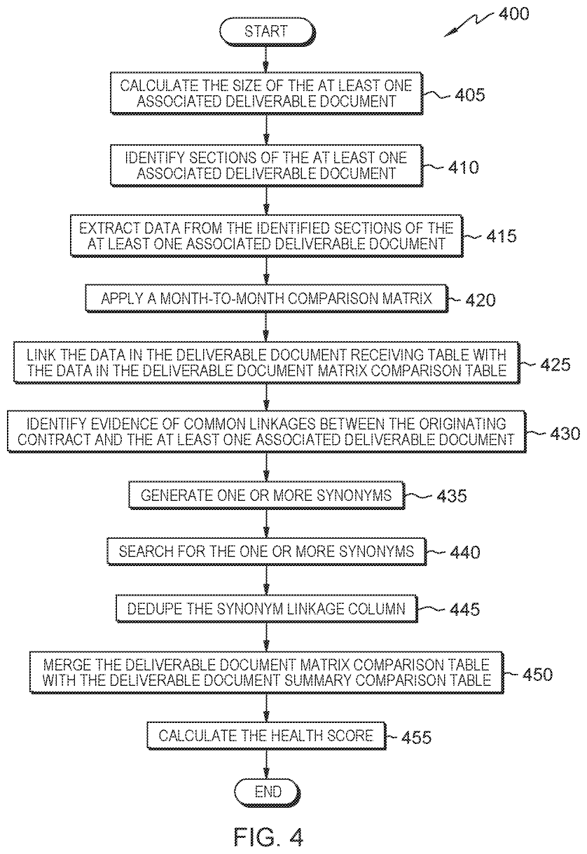

Troubled contracts program 122 operates to identify troubled contracts by analyzing data within an originating contract and at least one deliverable document associated with the contract and by outputting a health score based on the analysis of the data. In the depicted embodiment, troubled contracts program 122 is a standalone program. In another embodiment, troubled contracts program 122 may be integrated into another software product, such as a contract management software. In the depicted embodiment, troubled contracts program 122 resides on server 120. In another embodiment, troubled contracts program 122 may reside on user computing device 130 or on another computing device (not shown), provided that troubled contracts program 122 has access to network 110. In an embodiment, a user opts-in to troubled contracts program 122 and sets up a user profile with troubled contracts program 122. The setup component of troubled contracts program 122 is depicted and described in further detail with respect to FIG. 2. The operational steps of troubled contracts program 122 are depicted and described in further detail with respect to FIG. 3. The operational steps of an analysis step of troubled contracts program 122 are depicted and described in greater detail with respect to FIG. 4.

Database 124 operates as a repository for data received, used, and/or generated by troubled contracts program 122. A database is an organized collection of data. Data includes, but is not limited to, information about user preferences (e.g., general user system settings such as alert notifications for user computing device 130); information about alert notification preferences; information necessary to create a user profile; an originating contract; a list of requirements specified in the originating contract; at least one deliverable document associated with the contract; information associated with the at least one deliverable document associated with the contract (i.e., a name of the associated deliverable document, a unique document identification number of the deliverable document associated with the contract, the size of the at least one deliverable document associated with the contract, quantitative data, and/or sentiment analysis data); health metrics features (i.e., the size of the at least one deliverable document associated with the contract, quantitative data, sentiment analysis data, and/or key terms); health score produced for each requirement of the list of requirements from the analysis of the at least one deliverable document associated with the contract; and any other data received, used, and/or generated by troubled contracts program 122.

Database 124 can be implemented with any type of device capable of storing data and configuration files that can be accessed and utilized by server 120, such as a hard disk drive, a database server, or a flash memory. In an embodiment, database 124 is accessed by troubled contracts program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that troubled contracts program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Troubled contracts program 122 enables the authorized and secure processing of personal data.

Troubled contracts program 122 provides informed consent, with notice of the collection of personal and/or confidential company data, allowing the user to opt-in or to opt-out of processing personal and/or confidential company data. Consent can take several forms. Opt-in consent can impose on the user the opportunity to take an affirmative action before personal and/or confidential company data is processed. Alternatively, opt-out consent can impose on the user the opportunity to take an affirmative action to prevent the processing of personal and/or confidential company data before personal and/or confidential company data is processed. Troubled contracts program 122 provides information regarding personal and/or confidential company data and the nature (e.g., type, scope, purpose, duration, etc.) of the processing. Troubled contracts program 122 provides the user with copies of stored personal and/or confidential company data. Troubled contracts program 122 allows for the correction or completion of incorrect or incomplete personal and/or confidential company data. Troubled contracts program 122 allows for the immediate deletion of personal and/or confidential company data.

In an embodiment, the user of user computing device 130 can register with troubled contracts program 122. For example, the user completes a registration process, provides information, and authorizes the collection and analysis (i.e., opt-in) of relevant data on identified computing devices, (e.g., user computing device 130) by server 120 (e.g., via troubled contracts program 122). In various embodiments, a user can opt-in or opt-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In another embodiment, the user can define which forms of data server 120 can utilize in analyzing an originating contract or at least one deliverable document associated with the contract. In another embodiment, the user can opt-out of the analysis of the originating contract or the at least one deliverable document associated with the contract entirely. Such preferences can be stored in database 124.

User computing device 130 operates to run user interface 132 through which a user can interact with troubled contracts program 122 on server 120. A user is a party to a contract, i.e., one who makes a promise or set of promises to perform a duty and/or one who receives the benefits of the contract, i.e., the promisor and the promisee, respectively. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with troubled contracts program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132. User computing device 130 may include components as described in further detail in FIG. 5.

User interface 132 operates as a local user interface between troubled contracts program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from troubled contracts program 122 to a user via network 110. User interface 132 can also display or present alerts including information (such as graphics, text, and/or sound) sent from troubled contracts program 122 to a user via network 110. In an embodiment, user interface 132 is capable of sending and receiving data (i.e., to and from troubled contracts program 122 via network 110, respectively). Through user interface 132, a user can opt-in to troubled contracts program 122, create a user profile, and set user preferences and alert notification preferences.

A user preference is a setting that can be customized for a particular user. A set of default user preferences are assigned to each user of troubled contracts program 122. A user preference editor can be used to update values to change the default user preferences. User preferences that can be customized include, but are not limited to, general user system settings, specific user profile settings for troubled contracts program 122, alert notification settings, and machine-learned data collection and storage settings. Machine-learned data includes, but is not limited to, data regarding past results of iterations of troubled contracts program 122 and a user's previous response to an alert notification sent by troubled contracts program 122. Machine-learned data comes from troubled contracts program 122 self-learning how to analyze data within an originating contract and at least one deliverable document associated with the contract and how to output a health score produced from the analysis of the data within an originating contract and at least one deliverable document associated with the contract. Troubled contracts program 122 self-learns by tracking user activity and improves with each iteration of troubled contracts program 122.

FIG. 2 is a flowchart, generally designated 200, illustrating the operational steps for a setup component of trouble contracts program 122 of distributed data processing environment 100 of FIG. 1, in accordance with an embodiment of the present invention. In an embodiment, troubled contracts program 122 completes a one-time setup with a user. The one-time setup allows for troubled contracts program 122 to capture relevant information about the user to create a user profile. In an embodiment, trouble contracts program 122 receives a request from the user to opt-in. In an embodiment, troubled contracts program 122 requests information from the user. In an embodiment, troubled contracts program 122 receives the requested information from the user. In an embodiment, troubled contracts program 122 creates a user profile. In an embodiment, troubled contracts program 122 stores the user profile. It should be appreciated that the process depicted in FIG. 2 illustrates one possible iteration of troubled contracts program 122, which may be repeated for each opt-in request received by troubled contracts program 122.

In step 210, troubled contracts program 122 receives a request from the user to opt-in. In an embodiment, troubled contracts program 122 receives a request from the user to opt-in to troubled contracts program 122. In an embodiment, troubled contracts program 122 receives a request from the user to opt-in to troubled contracts program 122 through user interface 132 of user computing device 130. By opting-in, the user agrees to share data with database 124.

In step 220, troubled contracts program 122 requests information from the user. In an embodiment, troubled contracts program 122 requests information from the user through user interface 132 of user computing device 130. Information requested from the user includes, but is not limited to, information about user preferences (e.g., general user system settings such as alert notifications for user computing device 130); information about alert notification preferences; and information necessary to create a user profile. In an embodiment, responsive to receiving the request from the user to opt-in, troubled contracts program 122 requests information from the user.

In step 230, troubled contracts program 122 receives the requested information from the user. In an embodiment, troubled contracts program 122 receives the requested information from the user through user interface 132 of user computing device 130. In an embodiment, responsive to requesting information from the user, troubled contracts program 122 receives the requested information from the user.

In step 240, troubled contracts program 122 creates a user profile. In an embodiment, troubled contracts program 122 creates a user profile for the user. In an embodiment, troubled contracts program 122 creates a user profile with information input by the user during setup regarding the user as well as user preferences and alert notification preferences of the user. In an embodiment, responsive to receiving the requested information from the user, troubled contracts program 122 creates a user profile.

In step 250, troubled contracts program 122 stores the user profile. In an embodiment, troubled contracts program 122 stores the user profile in a database, e.g., database 124. In an embodiment, responsive to creating the user profile, troubled contracts program 122 stores the user profile.

FIG. 3 is a flowchart, generally designated 300, illustrating the operational steps of troubled contracts program 122 on server 120 within distributed data processing environment 100 of FIG. 1, in accordance with an embodiment of the present invention. In an embodiment, troubled contracts program 122 operates to analyze data within an originating contract and at least one deliverable document associated with the contract and to output a health score based on the analysis of the data. It should be appreciated that the process depicted in FIG. 3 illustrates one possible iteration of troubled contracts program 122, which may be repeated for each originating contract received by troubled contracts program 122.

In step 310, troubled contracts program 122 receives an originating contract. In an embodiment, troubled contracts program 122 receives an originating contract inputted by a user through user interface 132 of user computing device 130. In an embodiment, troubled contracts program 122 stores the originating contract in a database, e.g., database 124.

In step 320, troubled contracts program 122 identifies a list of requirements. In an embodiment, troubled contracts program 122 identifies a list of default, out of the box configured heuristic requirements. The list of default, out of the box configured heuristic requirements include, but are not limited to, key terms and headings. In an embodiment, troubled contracts program 122 identifies a list of requirements specified within the text of the originating contract. In one or more embodiments, troubled contracts program 122 identifies a list of requirements specified within a list or table of the originating contract. In an embodiment, troubled contracts program 122 identifies a list of requirements specified in the originating contract using a NLP technique.

In an embodiment, troubled contracts program 122 provides the list of default, out of the box configured heuristic requirements to the user for approval. In an embodiment, troubled contracts program 122 enables the user to approve of the one or more default, out of the box configured heuristic requirements. In an embodiment, troubled contracts program 122 enables the user to add one or more requirements to the one or more default, out of the box configured heuristic requirements. The one or more requirements are provided by the user in sentence format. The one or more default, out of the box configured heuristic requirements approved by the user and the one or more requirements added to the one or more default, out of the box configured heuristic requirements approved by the user are hereinafter referred to as “requirements”. The requirements will be used to compare the at least one deliverable document associated with the contract to the originating contract.

In an embodiment, troubled contracts program 122 stores the list of requirements in a database, e.g., database 124. In an embodiment, responsive to receiving an originating contract, troubled contracts program 122 identifies a list of requirements.

In step 330, troubled contracts program 122 trains a model. In an embodiment, troubled contracts program 122 trains a model to recognize the list of requirements specified in the originating contract (e.g., the Contract Data Requirements List (CDRL) specified in the originating contract). In an embodiment, troubled contracts program 122 trains the model to recognize which section of the at least one deliverable document associated with the contract is associated with which requirement of the list of requirements specified in the originating contract. In an embodiment, responsive to identifying a list of requirements, troubled contracts program 122 trains a model.

In step 340, troubled contracts program 122 receives the at least one deliverable document associated with the contract. The at least one deliverable document associated with the contract is a status tracking document, i.e., a document that provides an update on the status of the at least one deliverable document required in the originating contract. The at least one deliverable document associated with the contract may include, but is not limited to, a Weekly Status Report, a Monthly Status Report, a Final Report, a Data Dictionary, and an Extract, Transform, and Load (ETL) Script. The at least one deliverable document associated with the contract may be in one or more formats including, but not limited to, Microsoft® PowerPoint slides, Microsoft® Excel files, spreadsheets, web pages, diagrams, and flowcharts. In an embodiment, troubled contracts program 122 receives the at least one deliverable document associated with the contract at a pre-determined period of time, i.e., at an interval set by a user as a user preference, e.g., daily, weekly, or monthly. In an embodiment, troubled contracts program 122 receives the at least one deliverable document associated with the contract inputted by a user through user interface 132 of user computing device 130. In an embodiment, troubled contracts program 122 stores the at least one deliverable document associated with the contract in a database, e.g., database 124. In an embodiment, responsive to training a model, troubled contracts program 122 receives the at least one deliverable document associated with the contract.

In step 350, troubled contracts program 122 extracts data from the at least one deliverable document associated with the contract. In an embodiment, troubled contracts program 122 extracts data from the at least one deliverable document associated with the contract using NLP. Data extracted from the at least one deliverable document associated with the contract includes, but is not limited to, a unique document identification number (e.g., A001, A002, A003, and A004) of the deliverable document associated with the contract and a name of the deliverable document associated with the contract. In an embodiment, troubled contracts program 122 stores the data extracted from the at least one deliverable document associated with the contract in a database, e.g., database 124. In an embodiment, responsive to receiving the at least one deliverable document associated with the contract, troubled contracts program 122 extracts data from the at least one deliverable document associated with the contract.

For example, troubled contracts program 122 extracts data from four deliverable documents associated with the originating contract. The four deliverable documents include a Data Dictionary, an ETL Script, a Monthly Status Report, and a Final Report. Troubled contracts program 122 extracts the unique document identification number of the deliverable document associated with the contract and the name of the deliverable document associated with the contract.

In step 360, troubled contracts program 122 creates a first table. In an embodiment, troubled contracts program 122 creates a first table to manage the extracted data. In an embodiment, troubled contracts program 122 creates a first table with two headers: the name of the at least one deliverable document associated with the contract and the unique document identification number of the at least one deliverable document associated with the contract. The first table will hereinafter be referred to as the Deliverable Document Receiving Table. In an embodiment, troubled contracts program 122 inputs the data extracted from the at least one deliverable document associated with the contract into the Deliverable Document Receiving Table. In an embodiment, responsive to extracting data from the at least one deliverable document associated with the contract, troubled contracts program 122 creates a Deliverable Document Receiving Table.

Continuing the above example, troubled contracts program 122 creates Table A, a Deliverable Document Receiving Table, and inputs the data extracted from the four identified deliverable documents, including the unique document identification number of the at least one deliverable document associated with the contract and the name of the at least one deliverable document associated with the contract, into Table A.

TABLE A

| Deliverable Number | Deliverable Name |
|---|---|
| A001 | Data Dictionary |
| A002 | ETL Scripts |
| A003 | Monthly Status Report |
| A004 | Final Report |

In step 370, troubled contracts program 122 analyzes the at least one deliverable document associated with the contract. In an embodiment, troubled contracts program 122 analyzes the at least one deliverable document associated with the contract by applying health metrics to the at least one deliverable document associated with the contract. In an embodiment, troubled contracts program 122 applies health metrics to the at least one deliverable document associated with the contract to identify evidence of completion of each requirement of the list of requirements specified in the originating contract. The features of the health metrics used include, but are not limited to, character count, word count, sentiment analysis data, key terms, and quantitative data. A character count is a count of the letters, numerical digits, common punctuation marks, and whitespaces contained in a document. A word count is a count of the words contained in a document. Sentiment analysis is the process of computationally identifying and categorizing opinions expressed in a piece of text, especially to determine whether the writer's attitude towards a particular topic, product, etc. is positive, negative, or neutral. Sentiment analysis data is data derived from the sentiment analysis process. Quantitative data is the value of data in the form of counts or numbers where each dataset has a unique numerical value associated with it. The analysis of the at least one deliverable document associated with the contract is described in further detail with respect to flowchart 400 in FIG. 4. In an embodiment, responsive to creating a Deliverable Document Receiving Table, troubled contracts program 122 analyzes the at least one deliverable document associated with the contract.

In step 380, troubled contracts program 122 outputs a health score. In an embodiment, troubled contracts program 122 outputs a health score for each requirement of the list of requirements. In an embodiment, troubled contracts program 122 outputs a health score for each requirement of the list of requirements based on the analysis of the at least one deliverable document associated with the contract. In an embodiment, troubled contracts program 122 outputs a health score as an alert notification. In an embodiment, troubled contracts program 122 outputs a health score at a run time. In one or more embodiments, troubled contracts program 122 outputs a health score at a pre-determined period of time, i.e., at an interval set by a user as a user preference, e.g., daily, weekly, or monthly. In an embodiment, troubled contracts program 122 outputs a health score to the user through user interface 132 of user computing device 130. In an embodiment, troubled contracts program 122 stores the health score in a database, e.g., database 124. In an embodiment, responsive to analyzing the at least one deliverable document associated with the contract, troubled contracts program 122 outputs a health score.

In decision 390, troubled contracts program 122 determines whether the originating contract is complete (i.e., when the parties to an agreement fulfill their promise or set of promises). In an embodiment, responsive to troubled contracts program 122 outputting the health score, troubled contracts program 122 determines whether the originating contract is complete.

If troubled contracts program 122 determines the originating contract is not complete (decision 390, NO branch), then troubled contracts program 122 waits to receive at least one associated deliverable document (step 340). If troubled contracts program 122 determines the originating contract is complete (decision 390, YES branch), then troubled contracts program 122 ends.

FIG. 4 is a flowchart, generally designated 400, illustrating, in greater detail, the operational steps of analysis step 370 of troubled contracts program 122 on server 120 within distributed data processing environment 100 of FIG. 1, in accordance with an embodiment of the present invention. It should be appreciated that the process depicted in FIG. 4 illustrates one possible iteration of the analysis step of troubled contracts program 122, which may be repeated for each deliverable document associated with the contract received by troubled contracts program 122.

In step 405, troubled contracts program 122 calculates the size of the at least one deliverable document associated with the contract. In an embodiment, troubled contracts program 122 calculates the size of the at least one deliverable document associated with the contract by counting the number of characters in the at least one deliverable document associated with the contract. In one or more embodiments, troubled contracts program 122 calculates the size of the at least one deliverable document associated with the contract by counting the number of sentences written in the at least one deliverable document associated with the contract. In one or more embodiments, troubled contracts program 122 calculates the size of the at least one deliverable document associated with the contract by counting the number of paragraphs written in the at least one deliverable document associated with the contract. In one or more embodiments, troubled contracts program 122 calculates the size of the at least one deliverable document associated with the contract by counting the number of bullet points used in the at least one deliverable document associated with the contract. In an embodiment, troubled contracts program 122 inputs the calculated size of the at least one deliverable document associated with the contract into a second table. The second table will hereinafter be referred to as the Deliverable Document Matrix Comparison Table. In an embodiment, troubled contracts program 122 stores the calculated size of the at least one deliverable document associated with the contract in a database, e.g., database 124.

In step 410, troubled contracts program 122 identifies sections of the at least one deliverable document associated with the contract. In an embodiment, troubled contracts program 122 identifies sections of the at least one deliverable document associated with the contract related to the list of requirements. In one or more embodiments, troubled contracts program 122 identifies sections of the at least one deliverable document associated with the contract related to the list of requirements that contain quantitative data. For example, quantitative data can include hours worked and headcounts of staff. In one or more embodiments, troubled contracts program 122 identifies sections of the at least one deliverable document associated with the contract related to the list of requirements that contain sentiment analysis data. For example, sentiment analysis data can include indications of whether the writer's attitude is positive, negative, or neutral toward a particular topic of the at least one deliverable document associated with the contract. In an embodiment, troubled contracts program 122 identifies sections of the at least one deliverable document associated with the contract related to the list of requirements using one or more NLP techniques. The NLP techniques used include, but are not limited to, a bag-of-words model, a synonym generation and detection model, and a similarity algorithm. In an embodiment, responsive to calculating the size of the at least one deliverable document associated with the contract, troubled contracts program 122 identifies sections of the at least one deliverable document associated with the contract.

In step 415, troubled contracts program 122 extracts data from the identified sections of the at least one deliverable document associated with the contract. The data extracted from the identified sections of the at least one deliverable document associated with the contract includes, but is not limited to, data related to the list of requirements, quantitative data, and sentiment analysis data. In an embodiment, troubled contracts program 122 inputs the data extracted from the identified sections of the at least one deliverable document associated with the contract into the Deliverable Document Matrix Comparison Table. In an embodiment, responsive to identifying sections of the at least one deliverable document associated with the contract, troubled contracts program 122 extracts data from the identified sections of the at least one deliverable document associated with the contract.

In step 420, troubled contracts program 122 applies a month-to-month comparison matrix. In an embodiment, troubled contracts program 122 applies a month-to-month comparison matrix to the data inputted into the Deliverable Document Matrix Comparison Table. In an embodiment, troubled contracts program 122 applies a month-to-month comparison matrix to track changes in the data inputted into the Deliverable Document Matrix Comparison Table. In an embodiment, troubled contracts program 122 identifies the difference in size of the at least one deliverable document associated with the contract currently being analyzed from the at least one deliverable document associated with the contract previously analyzed, the difference in the headcount of the at least one deliverable document associated with the contract currently being analyzed from the at least one deliverable document associated with the contract previously analyzed, and the difference in the sentiment of the at least one deliverable document associated with the contract currently being analyzed from the at least one deliverable document associated with the contract previously analyzed.

A positive deviation in the data correlates with successful progress on or completion of a requirement on the list of requirements. A negative deviation in the data correlates with failure to make progress on or to complete a requirement on the list of requirements. In an embodiment, responsive to creating the Deliverable Document Matrix Comparison Table, troubled contracts program 122 applies a month-to-month comparison matrix.

For example, troubled contracts program 122 creates Table B, a Deliverable Document Matrix Comparison Table. Table B contains the extracted data from the identified sections of the at least one deliverable document associated with the contract as well as the results for three months of the month-to-month comparison matrix. The data in Table B includes, but is not limited to, the unique document identification number of the originating contract, the month the at least one deliverable document associated with the contract was received, the text of the at least one deliverable document associated with the contract, the size of the at least one deliverable document associated with the contract, the difference in size of the at least one deliverable document associated with the contract currently being analyzed from the at least one deliverable document associated with the contract previously analyzed, a headcount, the difference in the headcount of the at least one deliverable document associated with the contract currently being analyzed from the at least one deliverable document associated with the contract previously analyzed, a sentiment, and the difference in the sentiment of the at least one deliverable document associated with the contract currently being analyzed from the at least one deliverable document associated with the contract previously analyzed.

TABLE B

| | | | MSR | MSR | | Headcount | | Sentiment |
|---|---|---|---|---|---|---|---|---|
| Contract | MSR | MSR Body | Size | Diff | Headcount | Diff | Sentiment | Diff |
| 1 | January 2019 | During | 1400 | 0 | 10 | 0 | 0.25 | 0 |
| | | January . . . | | | | | | |
| 1 | February 2019 | During | 1375 | −25 | 10 | 0 | 0.54 | +0.29 |
| | | February . . . | | | | | | |
| 1 | March 2019 | During | 1425 | +50 | 10 | 0 | 0.42 | −0.12 |
| | | March . . . | | | | | | |

In step 425, troubled contracts program 122 links the data in the Deliverable Document Receiving Table with the data in the Deliverable Document Matrix Comparison Table. In an embodiment, troubled contracts program 122 links the data in the Deliverable Document Receiving Table with the data in the Deliverable Document Matrix Comparison Table to create a third table. The third table contains data including, but not limited to, the unique document identification number of the originating contract, the unique document identification number of the at least one deliverable document associated with the contract, the name given to the at least one associated deliverable document, the date the at least one deliverable document associated with the contract was produced, and the text of the at least one deliverable document associated with the contract. The third table will hereinafter be referred to as the Deliverable Document Summary Comparison Table. In an embodiment, responsive to applying a month-to-month comparison matrix, troubled contracts program 122 links the data in the Deliverable Document Receiving Table with the data in the Deliverable Document Matrix Comparison Table.

For example, troubled contracts program 122 creates Table C, a Deliverable Document Summary Comparison Table.

TABLE C

| | Deliverable | Deliverable | | MSR |
|---|---|---|---|---|
| Contract | Number | Name | MSR | Body |
| 1 | A001 | ETL Scripts | Jan 2019 | During |
| | | | | Jan . . . |
| 1 | A001 | ETL Scripts | Feb 2019 | During |
| | | | | Feb . . . |
| 1 | A001 | ETL Scripts | Mar 2019 | During |
| | | | | Mar . . . |
| 1 | A002 | Data Dictionary | Jan 2019 | During |
| | | | | Jan . . . |
| 1 | A002 | Data Dictionary | Feb 2019 | During |
| | | | | Feb . . . |
| s | A002 | Data Dictionary | Mar 2019 | During |
| | | | | Mar . . . |

In step 430, troubled contracts program 122 identifies evidence of common linkages between the originating contract and the at least one deliverable document associated with the contract. In an embodiment, troubled contracts program 122 identifies evidence of common linkages between the originating contract and the at least one deliverable document associated with the contract by searching the column of the Deliverable Document Summary Comparison Table containing the text of the at least one deliverable document associated with the contract (i.e., the MSR Body Column).

In an embodiment, troubled contracts program 122 creates a first column. In an embodiment, troubled contracts program 122 creates a first column in the Deliverable Document Summary Comparison Table. In an embodiment, troubled contracts program 122 inputs evidence of the common linkages between the originating contract and the at least one deliverable document associated with the contract found in the first column created. The first column created will hereinafter be referred to as the Completion of Requirements Evidence Column. In an embodiment, responsive to linking the data in the Deliverable Document Receiving Table with the data in the Deliverable Document Matrix Comparison Table, troubled contracts program 122 identifies evidence of common linkages between the originating contract and the at least one deliverable document associated with the contract.

For example, troubled contracts program 122 creates column D, the Completion of Requirements Evidence Column, and inputs evidence of common linkages between the originating contract and the at least one deliverable document associated with the contract into the Completion of Requirements Evidence Column.

TABLE C
with column D:

| | Deliverable | Deliverable | | MSR | Column D (Completion of |
|---|---|---|---|---|---|
| Contract | Number | Name | MSR | Body | Requirements Evidence) |
| 1 | A001 | ETL Scripts | Jan 2019 | During | [Text pertaining to A001 from Jan |
| | | | | Jan . . . | 2019] |
| 1 | A001 | ETL Scripts | Feb 2019 | During | [Text pertaining to A001 from Feb |
| | | | | Feb . . . | 2019] |
| 1 | A001 | ETL Scripts | Mar 2019 | During | [Text pertaining to A001 from Mar |
| | | | | Mar . . . | 2019] |
| 1 | A002 | Data Dictionary | Jan 2019 | During | [Text pertaining to A002 from Jan |
| | | | | Jan . . . | 2019] |
| 1 | A002 | Data Dictionary | Feb 2019 | During | [Text pertaining to A002 from Feb |
| | | | | Feb . . . | 2019] |
| s | A002 | Data Dictionary | Mar 2019 | During | [Text pertaining to A002 from Mar |
| | | | | Mar . . . | 2019] |

In step 435, troubled contracts program 122 generates one or more synonyms. In an embodiment, troubled contracts program 122 generates one or more synonyms of the list of requirements. In an embodiment, troubled contracts program 122 generates one or more synonyms that mean exactly or nearly the same as another word or phrase found in the list of requirements. In an embodiment, troubled contracts program 122 generates one or more synonyms of the list of requirements using NLP. In one or more embodiments, troubled contracts program 122 enables the user to generate one or more synonyms of the list of requirements manually.

In an embodiment, troubled contracts program 122 creates a second column. In an embodiment, troubled contracts program 122 creates a second column in the Deliverable Document Summary Comparison Table. In an embodiment, troubled contracts program 122 creates a second column in the Deliverable Document Summary Comparison Table for the one or more synonyms of the list of requirements generated. The second column will hereinafter be referred to as the Generated Synonym Column. In an embodiment, troubled contracts program 122 inputs the one or more synonyms of the list of requirements into the Generated Synonym Column. In an embodiment, responsive to identifying common linkages between the originating contract and the at least one deliverable document associated with the contract, troubled contracts program 122 generates one or more synonyms.

For example, troubled contracts program 122 creates column E, the Generated Synonym Column, and inputs the one or more synonyms of the list of requirements generated into the Generated Synonym Column.

Table C with column E:

| | | | | | Column D | Column E |
|---|---|---|---|---|---|---|
| | Deliverable | Deliverable | | MSR | (Completion of | (Generated |
| Contract | Number | Name | MSR | Body | Requirement Evidence) | Synonym) |
| 1 | A001 | ETL Scripts | January | During | [Text pertaining to A001 | Synonym |
| | | | 2019 | January . . . | from January 2019] | |
| 1 | A001 | ETL Scripts | February | During | [Text pertaining to A001 | Synonym |
| | | | 2019 | February . . . | from February 2019] | |
| 1 | A001 | ETL Scripts | March | During | [Text pertaining to A001 | Synonym |
| | | | 2019 | March . . . | from March 2019] | |
| 1 | A002 | Data | January | During | [Text pertaining to A002 | Synonym |
| | | Dictionary | 2019 | January . . . | from January 2019] | |
| 1 | A002 | Data | February | During | [Text pertaining to A002 | Synonym |
| | | Dictionary | 2019 | February . . . | from February 2019] | |
| s | A002 | Data | March | During | [Text pertaining to A002 | Synonym |
| | | Dictionary | 2019 | March . . . | from March 2019] | |

In step 440, troubled contracts program 122 searches for the one or more synonyms of the list of requirements. In an embodiment, troubled contracts program 122 searches for the one or more synonyms of the list of requirements in the Completion of Requirements Evidence Column of the Deliverable Document Summary Comparison Table.

In an embodiment, troubled contracts program 122 identifies the one or more synonyms of the list of requirements found in the Completion of Requirements Evidence Column of the Deliverable Document Summary Comparison Table.

In an embodiment, troubled contracts program 122 creates a third column. In an embodiment, troubled contracts program 122 creates a third column in the Deliverable Document Summary Comparison Table. In an embodiment, troubled contracts program 122 creates a third column when one or more synonyms of the list of requirements are found in the Completion of Requirements Evidence Column of the Deliverable Document Summary Comparison Table. The third column created will hereinafter be referred to as the Synonym Linkage Column.

In an embodiment, troubled contracts program 122 inputs a value into the Synonym Linkage Column. In an embodiment, troubled contracts program 122 inputs a value into the Synonym Linkage Column indicating whether one or more synonyms of the list of requirements were found in the Completion of Requirements Evidence Column of the Deliverable Document Summary Comparison Table. E represents the value. E is a value greater than 0 if a synonym is found. E is equal to 0 if a synonym is not found.

In an embodiment, responsive to generating one or more synonyms, troubled contracts program 122 searches for the one or more synonyms of the list of requirements.

For example, troubled contracts program 122 creates column F, the Synonym Linkage Column, in Table C. If troubled contracts program 122 finds a synonym in the Completion of Requirements Evidence Column of the Deliverable Document Summary Comparison Table, then troubled contracts program 122 enters D+E into the Synonym Linkage Column. E is equal to a value greater than 0. If troubled contracts program 122 does not find a synonym in the Completion of Requirements Evidence Column of the Deliverable Document Summary Comparison Table, then troubled contracts program 122 enters only D into the Synonym Linkage Column. E, in this case, is equal to 0.

| | | | | | Column D | Column E | Column F |
|---|---|---|---|---|---|---|---|
| | Deliverable | Deliverable | | MSR | (Completion of | (Generated | (Synonym |
| Contract | Number | Name | MSR | Body | Requirement Evidence) | Synonym) | Linkage) |
| 1 | A001 | ETL Scripts | January | During | [Text pertaining to A001 | Synonym | D + E |
| | | | 2019 | January . . . | from January 2019] | | |
| 1 | A001 | ETL Scripts | February | During | [Text pertaining to A001 | Synonym | D + E |
| | | | 2019 | February . . . | from February 2019] | | |
| 1 | A001 | ETL Scripts | March | During | [Text pertaining to A001 | Synonym | D + E |
| | | | 2019 | March . . . | from March 2019] | | |
| 1 | A002 | Data | January | During | [Text pertaining to A002 | Synonym | D + E |
| | | Dictionary | 2019 | January . . . | from January 2019] | | |
| 1 | A002 | Data | February | During | [Text pertaining to A002 | Synonym | D + E |
| | | Dictionary | 2019 | February . . . | from February 2019] | | |
| s | A002 | Data | March | During | [Text pertaining to A002 | Synonym | D + E |
| | | Dictionary | 2019 | March . . . | from March 2019] | | |

In step 445, troubled contracts program 122 dedupes the Synonym Linkage Column. In an embodiment, troubled contracts program 122 dedupes the Synonym Linkage Column by eliminating any redundant duplicate data. In an embodiment, responsive to searching for the one or more synonyms of the list of requirements, troubled contracts program 122 dedupes the Synonym Linkage Column.

In step 450, troubled contracts program 122 merges the Deliverable Document Matrix Comparison Table with the Deliverable Document Summary Comparison Table. In an embodiment, troubled contracts program 122 merges the Deliverable Document Matrix Comparison Table with the Deliverable Document Summary Comparison Table to create one complete table of the evidence of completion of each requirement of the list of requirements. In an embodiment, troubled contracts program 122 creates a fourth table. The fourth table will hereinafter be referred to as the Deliverable Document Complete Comparison Table. In an embodiment, responsive to deduping the Completion/Delivery Evidence Column, troubled contracts program 122 merges the Deliverable Document Matrix Comparison Table with the Deliverable Document Summary Comparison Table.

In step 455, troubled contracts program 122 calculates a health score. In an embodiment, troubled contracts program 122 calculates a health score by applying a success model to the evidence of completion of each requirement of the list of requirements found in the Deliverable Document Complete Comparison Table. In an embodiment, troubled contracts program 122 scores the evidence of completion of each requirement of the list of requirements. In an embodiment, troubled contracts program 122 scores the evidence of completion of each requirement of the list of requirements as “Successful” if the score of the evidence is above a pre-set failure threshold of the success model. In an embodiment, troubled contracts program 122 scores the evidence of completion of each requirement of the list of requirements as “Not Successful” if the score of the evidence is below the pre-set failure threshold of the success model. In an embodiment, responsive to merging the Deliverable Document Matrix Comparison Table with the Deliverable Document Summary Comparison Table, troubled contracts program 122 calculates a health score.

FIG. 5 is a block diagram illustrating the components of computer device 500, suitable for server 120 and/or user computing device 130 within distributed data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Computer device 500 includes processor(s) 504, memory 506, cache 516, communications fabric 502, persistent storage 508, input/output (I/O) interface(s) 512, and communications unit 510.

Communications fabric 502 provides communications between memory 506, cache 516, persistent storage 508, input/output (I/O) interface(s) 512, and communications unit 510. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a cross switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Program instructions and data (e.g., software and data) used to practice embodiments of the present invention may be stored in persistent storage 508 and in memory 506 for execution and/or access by one or more of the respective computer processor(s) 504 via cache 516. In an embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508. Software and data can be stored in persistent storage 508 for access and/or execution by one or more of the respective processor(s) 504 via cache 516. With respect to user computing device 130, software and data includes user interface 132. With respect to server 120, software and data includes troubled contracts program 122.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data (e.g., software and data) used to practice embodiments of the present invention may be downloaded to persistent storage 508 through communications unit 510.

I/O interface(s) 512 allows for input and output of data with other devices that may be connected to server 120 and/or user computing device 130. For example, I/O interface(s) 512 may provide a connection to external device(s) 518, such as a keyboard, a keypad, a touch screen, and/or some other suitable input device. External device(s) 518 can also include portable computer readable storage media, such as, for example, thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a contract;
identifying, by one or more processors, a list of requirements of the contract using a first Natural Language Processing (NLP) technique;
training, by one or more processors, a model to recognize the list of requirements of the contract;
receiving, by one or more processors, at least one deliverable document associated with the contract;
applying, by one or more processors, a plurality of health metrics to the at least one deliverable document associated with the contract to identify evidence of completion of each requirement of the list of requirements of the contract; and
outputting, by one or more processors, a health score for each requirement of the list of requirements of the contract.

2. The computer-implemented method of claim 1, wherein receiving the at least one deliverable document associated with the contract further comprises:
extracting, by one or more processors, a first set of data from the at least one deliverable document associated with the contract using the first NLP technique; and
creating, by one or more processors, a first table to manage the first set of data extracted from the at least one deliverable document associated with the contract.

3. The computer-implemented method of claim 1, wherein applying the plurality of health metrics to the at least one deliverable document associated with the contract to identify the evidence of completion of each requirement of the list of requirements of the contract further comprises:
calculating, by one or more processors, a size of the at least one deliverable document associated with the contract;
identifying, by one or more processors, one or more sections of the at least one deliverable document associated with the contract related to the list of requirements of the contract using a second NLP technique;
extracting, by one or more processors, a second set of data from the one or more sections of the at least one deliverable document associated with the contract identified as related to the list of requirements of the contract;
creating, by one or more processors, a second table to manage the second set of data;
applying, by one or more processors, a month-to-month comparison matrix to the second set of data to track one or more changes in the second set of data;
creating, by one or more processors, a third table by linking the data in the first table and the data in the second table;
identifying, by one or more processors, evidence of a common linkage between the contract and the at least one deliverable document associated with the contract in a column of the third table containing a set of text of the at least one deliverable document associated with the contract;
generating, by one or more processors, one or more synonyms of the list of requirements using the second NLP technique;
identifying, by one or more processors, the one or more synonyms of the list of requirements found in a first column of the third table;
merging, by one or more processors, the data in the second table with the data in the third table to create a fourth table with the evidence of completion of each requirement of the list of requirements; and
calculating, by one or more processors, the health score for each requirement of the list of requirements of the contract by applying a success-model with a pre-set failure threshold to the evidence of completion of each requirement of the list of requirements of the contract.

4. The computer-implemented method of claim 3, wherein the size of the at least one deliverable document associated with the contract is calculated by counting a plurality of characters in the at least one deliverable document associated with the contract, by counting one or more sentences written in the at least one deliverable document associated with the contract, by counting one or more paragraphs written in the at least one deliverable document associated with the contract, or by counting one or more bullet points used in the at least one deliverable document associated with the contract.

5. The computer-implemented method of claim 3, wherein the one or more changes tracked in the second set of data includes a difference in the size of the at least one deliverable document associated with the contract currently being analyzed from the at least one deliverable document associated with the contract previously analyzed, a difference in a headcount of the at least one deliverable document associated with the contract currently being analyzed from the at least one deliverable document associated with the contract previously analyzed, and a difference in a sentiment of the at least one deliverable document associated with the contract currently being analyzed from the at least one deliverable document associated with the contract previously analyzed.

6. The computer-implemented method of claim 3, wherein calculating the health score for each requirement of the list of requirements of the contract by applying the success-model with the pre-set failure threshold to the evidence of completion of each requirement of the list of requirements of the contract further comprises:
scoring, by one or more processors, the evidence of completion of each requirement of the list of requirements of the contract; and
classifying, by one or more processors, the evidence of completion of each requirement of the list of requirements of the contract based on the health score calculated.

7. The computer-implemented method of claim 6, wherein the evidence of completion of each requirement of the list of requirements of the contract is classified as “successful” when the evidence of completion shows progress on a requirement on the list of requirements and scores above the pre-set failure threshold of the success-model or as “not successful” when the evidence of completion shows failure to make progress on a requirement on the list of requirements and scores below the pre-set failure threshold of the success-model.

8. A computer program product comprising:
one or more computer readable storage media and program instructions stored on the one or more computer readable storage media, the program instructions comprising:
program instructions to receive a contract;
program instructions to identify a list of requirements of the contract using a first Natural Language Processing (NLP) technique;
program instructions to train a model to recognize the list of requirements of the contract;
program instructions to receive at least one deliverable document associated with the contract;
program instructions to apply a plurality of health metrics to the at least one deliverable document associated with the contract to identify evidence of completion of each requirement of the list of requirements of the contract; and
program instructions to output a health score for each requirement of the list of requirements of the contract.

9. The computer program product of claim 8, wherein receiving the at least one deliverable document associated with the contract further comprises:
program instructions to extract a first set of data from the at least one deliverable document associated with the contract using the first NLP technique; and
program instructions to create a first table to manage the first set of data extracted from the at least one deliverable document associated with the contract.

10. The computer program product of claim 8, wherein applying the plurality of health metrics to the at least one deliverable document associated with the contract to identify the evidence of completion of each requirement of the list of requirements of the contract further comprises:
program instructions to calculate a size of the at least one deliverable document associated with the contract;
program instructions to identify one or more sections of the at least one deliverable document associated with the contract related to the list of requirements of the contract using a second NLP technique;
program instructions to extract a second set of data from the one or more sections of the at least one deliverable document associated with the contract identified as related to the list of requirements of the contract;
program instructions to create a second table to manage the second set of data;
program instructions to apply a month-to-month comparison matrix to the second set of data to track one or more changes in the second set of data;
program instructions to create a third table by linking the data in the first table and the data in the second table;
program instructions to identify evidence of a common linkage between the contract and the at least one deliverable document associated with the contract in a column of the third table containing a set of text of the at least one deliverable document associated with the contract;
program instructions to generate one or more synonyms of the list of requirements using the second NLP technique;
program instructions to identify the one or more synonyms of the list of requirements found in a first column of the third table;
program instructions to merge the data in the second table with the data in the third table to create a fourth table with the evidence of completion of each requirement of the list of requirements; and
program instructions to calculate the health score for each requirement of the list of requirements of the contract by applying a success-model with a pre-set failure threshold to the evidence of completion of each requirement of the list of requirements of the contract.

11. The computer program product of claim 10, wherein the size of the at least one deliverable document associated with the contract is calculated by counting a plurality of characters in the at least one deliverable document associated with the contract, by counting one or more sentences written in the at least one deliverable document associated with the contract, by counting one or more paragraphs written in the at least one deliverable document associated with the contract, or by counting one or more bullet points used in the at least one deliverable document associated with the contract.

12. The computer program product of claim 10, wherein the one or more changes tracked in the second set of data includes a difference in the size of the at least one deliverable document associated with the contract currently being analyzed from the at least one deliverable document associated with the contract previously analyzed, a difference in a headcount of the at least one deliverable document associated with the contract currently being analyzed from the at least one deliverable document associated with the contract previously analyzed, and a difference in a sentiment of the at least one deliverable document associated with the contract currently being analyzed from the at least one deliverable document associated with the contract previously analyzed.

13. The computer program product of claim 10, wherein calculating the health score for each requirement of the list of requirements of the contract by applying the success-model with the pre-set failure threshold to the evidence of completion of each requirement of the list of requirements of the contract further comprises:
program instructions to score the evidence of completion of each requirement of the list of requirements of the contract; and
program instructions to classify the evidence of completion of each requirement of the list of requirements of the contract based on the health score calculated.

14. The computer program product of claim 13, wherein the evidence of completion of each requirement of the list of requirements of the contract is classified as “successful” when the evidence of completion shows progress on a requirement on the list of requirements and scores above the pre-set failure threshold of the success-model or as “not successful” when the evidence of completion shows failure to make progress on a requirement on the list of requirements and scores below the pre-set failure threshold of the success-model.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a contract;
program instructions to identify a list of requirements of the contract using a first Natural Language Processing (NLP) technique;
program instructions to train a model to recognize the list of requirements of the contract;
program instructions to receive at least one deliverable document associated with the contract;
program instructions to apply a plurality of health metrics to the at least one deliverable document associated with the contract to identify evidence of completion of each requirement of the list of requirements of the contract; and
program instructions to output a health score for each requirement of the list of requirements of the contract.

16. The computer system of claim 15, wherein receiving the at least one deliverable document associated with the contract further comprises:
program instructions to extract a first set of data from the at least one deliverable document associated with the contract using the first NLP technique; and
program instructions to create a first table to manage the first set of data extracted from the at least one deliverable document associated with the contract.

17. The computer system of claim 15, wherein applying the plurality of health metrics to the at least one deliverable document associated with the contract to identify the evidence of completion of each requirement of the list of requirements of the contract further comprises:
program instructions to calculate a size of the at least one deliverable document associated with the contract;
program instructions to identify one or more sections of the at least one deliverable document associated with the contract related to the list of requirements of the contract using a second NLP technique;
program instructions to extract a second set of data from the one or more sections of the at least one deliverable document associated with the contract identified as related to the list of requirements of the contract;
program instructions to create a second table to manage the second set of data;
program instructions to apply a month-to-month comparison matrix to the second set of data to track one or more changes in the second set of data;
program instructions to create a third table by linking the data in the first table and the data in the second table;
program instructions to identify evidence of a common linkage between the contract and the at least one deliverable document associated with the contract in a column of the third table containing a set of text of the at least one deliverable document associated with the contract;
program instructions to generate one or more synonyms of the list of requirements using the second NLP technique;
program instructions to identify the one or more synonyms of the list of requirements found in a first column of the third table;
program instructions to merge the data in the second table with the data in the third table to create a fourth table with the evidence of completion of each requirement of the list of requirements; and
program instructions to calculate the health score for each requirement of the list of requirements of the contract by applying a success-model with a pre-set failure threshold to the evidence of completion of each requirement of the list of requirements of the contract.

18. The computer system of claim 17, wherein the size of the at least one deliverable document associated with the contract is calculated by counting a plurality of characters in the at least one deliverable document associated with the contract, by counting one or more sentences written in the at least one deliverable document associated with the contract, by counting one or more paragraphs written in the at least one deliverable document associated with the contract, or by counting one or more bullet points used in the at least one deliverable document associated with the contract.

19. The computer system of claim 17, wherein calculating the health score for each requirement of the list of requirements of the contract by applying the success-model with the pre-set failure threshold to the evidence of completion of each requirement of the list of requirements of the contract further comprises:
program instructions to score the evidence of completion of each requirement of the list of requirements of the contract; and
program instructions to classify the evidence of completion of each requirement of the list of requirements of the contract based on the health score calculated.

20. The computer system of claim 19, wherein the evidence of completion of each requirement of the list of requirements of the contract is classified as “successful” when the evidence of completion shows progress on a requirement on the list of requirements and scores above the pre-set failure threshold of the success-model or as “not successful” when the evidence of completion shows failure to make progress on a requirement on the list of requirements and scores below the pre-set failure threshold of the success-model.
